(19) United States
(12) Patent Application Publication
(10) Pub. No.: US 2026/0358861 A1
(43) Pub. Date: Nov. 12, 2026

(54) FOLDABLE DISPLAY DEVICE AND ELECTRONIC DEVICE INCLUDING THE SAME

(71) Applicant: Samsung Display Co., LTD., Yongin-si (KR)

(72) Inventor: Se Ja Chul HWANG, Yongin-si (KR)

(21) Appl. No.: 19/536,536

(22) Filed: Feb. 11, 2026

(30) Foreign Application Priority Data
May 12, 2025 (KR) 10-2025-0061061

(51) Int. Cl. G06F 1/16

(52) U.S. Cl. CPC G06F 1/1652

(57) ABSTRACT

A foldable display device includes a cover structure including first to third non-folding cover portions arranged in a first direction, a first folding cover portion disposed between the first and second non-folding cover portions, and a second folding cover portion disposed between the second and third non-folding cover portions; a display panel disposed on the cover structure, and including first to third non-folding portions overlapping the first to third non-folding cover portions, respectively, of the cover structure, and first and second folding portions overlapping the first and second folding cover portions, respectively; and a reflective member disposed on a surface of the second folding cover portion of the cover structure opposite to a surface of the second folding cover portion facing the display panel. The first and second folding portions of the display panel are folded and unfolded by the first and second folding cover portions, respectively.

This application claims priority to Korean Patent Application No. 10-2025-0061061, filed on May 12, 2025, and all the benefits accruing therefrom under 35 U.S.C. §119, the content of which in its entirety is herein incorporated by reference.

### BACKGROUND

### 1. Field

The disclosure relates to a foldable display device and an electronic device including the same.

### DESCRIPTION OF THE RELATED ART

The application range of display devices is expanding not only to monitors of computers and TVs but also to personal portable devices, and research is being conducted on display devices that have a relatively large display area and reduced volume and weight.

Recently, flexible display devices that may be bent or folded like paper while still displaying images are gaining attention as next-generation display devices. Flexible display devices may be classified into bendable, rollable, and foldable types, which may be bent, rolled, or folded, respectively. These flexible display devices offer advantages in terms of space utilization, interior design, and aesthetics, and may find applications in a variety of fields.

### SUMMARY

One feature of the disclosure is to provide a foldable display device having a folding structure configured not to directly expose a display screen to the outside, and also capable of providing notification images such as time, messages, and emails in a folded state without adding a separate display screen to the exterior.

The features of the disclosure are not limited to those mentioned above, and other objectives not explicitly stated will be clearly understood by those skilled in the art based on the following description.

In an embodiment of the disclosure, a foldable display device includes a cover structure including first, second, and third non-folding cover portions that are arranged in a first direction, a first folding cover portion that is disposed between the first and second non-folding cover portions, and a second folding cover portion that is disposed between the second and third non-folding cover portions; a display panel disposed on the cover structure, and including first, second, and third non-folding portions that overlap the first, second, and third non-folding cover portions, respectively, of the cover structure, and first and second folding portions that overlap the first and second folding cover portions, respectively; and a reflective member disposed on a surface of the second folding cover portion of the cover structure that is opposite to a surface of the second folding cover portion facing the display panel, where the first and second folding portions of the display panel are folded and unfolded by the first and second folding cover portions, respectively, of the cover structure.

In an embodiment, the first and second folding cover portions are each folded in an in-folding manner toward the second non-folding cover portion in the first direction, the second folding cover portion is folded to have an inclined surface near the third non-folding cover portion, and the reflective member overlaps the inclined surface.

In an embodiment, when the first and second folding cover portions are folded, the third non-folding portion and the third non-folding cover portion are disposed on the second non-folding portion and the second non-folding cover portion, the first non-folding portion and the first non-folding cover portion are disposed on the third non-folding portion and the third non-folding cover portion, the second folding cover portion and the reflective member are disposed outside the second and third non-folding cover portions, and one side of the first non-folding portion of the display panel overlaps the reflective member.

In an embodiment, when the first and second folding cover portions are folded, only the side of the first non-folding portion that overlaps the reflective member displays an image.

In an embodiment, when the first and second folding cover portions are folded, the image displayed by the side of the first non-folding portion that overlaps the reflective member is reflected by the reflective member and provided to the outside.

In an embodiment, when the first and second folding cover portions are folded, a screen refresh rate of the side of the first non-folding portion that overlaps the reflective member is 1 hertz (Hz) or less.

In an embodiment, the inclined surface is a planar surface, and an inclination of the inclined surface is in a range of 20° to 70°.

In an embodiment, the inclined surface includes a curved surface, and the reflective member is folded to have a shape identical to that of the inclined surface.

In an embodiment, according to a feature of the disclosure, a foldable display device includes a cover member including first, second, and third cover members that are arranged in a first direction; a display panel disposed on the cover member, and including first, second, and third non-folding portions that overlap the first, second, and third cover members, respectively, a first folding portion that is disposed between the first and second non-folding portions, and a second folding portion that is disposed between the second and third non-folding portions; a hinge member disposed inside the cover member, and including a first hinge member that overlaps the first folding portion of the display panel and connects the first and second cover members, and a second hinge member that overlaps the second folding portion of the display panel and connects the second and third cover members; and a reflective member disposed on a surface of the second hinge member that is opposite to a surface of the second hinge member facing the display panel, where the surface of the second hinge member opposite to the surface of the second hinge member facing the display panel includes a first inclined surface overlapping the third cover member, the reflective member overlaps the first inclined surface of the second hinge member, and the first and second folding portions of the display panel are folded and unfolded by the first and second hinge members, respectively.

In an embodiment, the first and second folding portions of the display panel are each folded in an in-folding manner toward the second non-folding portion in the first direction, and when the first and second folding portions are folded, the third non-folding portion and the third cover member are disposed on the second non-folding portion and the second cover member, the first non-folding portion and the first cover member are disposed on the third non-folding portion and the third cover member, and a portion of the hinge member and the reflective member are exposed to the outside and disposed outside the cover member.

In an embodiment, when the first and second folding portions are folded, one side of the first non-folding portion of the display panel overlaps the reflective member.

In an embodiment, when the first and second folding portions are folded, only the side of the first non-folding portion that overlaps the reflective member displays an image.

In an embodiment, when the first and second folding portions are folded, an image displayed by the side of the first non-folding portion that overlaps the reflective member is reflected by the reflective member and provided to the outside.

In an embodiment, when the first and second folding portions are folded, a screen refresh rate of the side of the first non-folding portion that overlaps the reflective member is 1 hertz (Hz) or less.

In an embodiment, the first inclined surface is a planar surface, and an inclination of the first inclined surface is in a range of 20° to 70°.

In an embodiment, the surface of the second hinge member facing the display panel includes a second inclined surface overlapping the second cover member, and the first and second inclined surfaces have different shapes from each other.

In an embodiment, the first inclined surface includes a curved surface.

In an embodiment, the surface of the second hinge member facing the display panel includes a second inclined surface overlapping the second cover member, and the second inclined surface has a shape identical to that of the first inclined surface.

In an embodiment, when the display panel is unfolded, the hinge member and the reflective member are not exposed to the outside by the cover member.

In an embodiment of the disclosure, an electronic device includes a display device for displaying an image; and a processor configured to transmit image data signals for displaying the image to the display device, where the display device includes: a cover member including first, second, and third cover members that are arranged in a first direction; a display panel disposed on the cover member and including first, second, and third non-folding portions that overlap the first, second, and third cover members, respectively, a first folding portion that is disposed between the first and second non-folding portions, and a second folding portion that is disposed between the second and third non-folding portions; a hinge member disposed inside the cover member and including a first hinge member that overlaps the first folding portion of the display panel and connects the first and second cover members, and a second hinge member that overlaps the second folding portion of the display panel and connects the second and third cover members; and a reflective member disposed on a surface of the second hinge member that is opposite to a surface of the second hinge member facing the display panel, the surface of the second hinge member that is opposite to the surface of the second hinge member facing the display panel includes a first inclined surface overlapping the third cover member, the reflective member overlaps the first inclined surface of the second hinge member, and the first and second folding portions of the display panel are folded and unfolded by the first and second hinge members, respectively.

In an embodiment, according to the aforementioned and other embodiments of the disclosure, a foldable display device capable of providing notification images such as time, messages, and emails using a reflective member without a separate display screen on the exterior in the folded state may be provided.

In an embodiment, it should be noted that the effects of the disclosure are not limited to those described above, and other effects of the disclosure will be apparent from the following description.

### BRIEF DESCRIPTION OF THE DRAWINGS

The above and other advantages and features of the disclosure will become more apparent by describing embodiments thereof in detail with reference to the attached drawings, in which:

FIG. 1 is a perspective view of an embodiment of a display device;

FIG. 2 is a perspective view illustrating a folded state of the display device of FIG. 1;

FIG. 3 is a cross-sectional view, taken along line X1-X1′, of the display device of FIG. 2;

FIG. 4 is an enlarged cross-sectional view of portion B1 in FIG. 3;

FIG. 5 is a cross-sectional view illustrating a modification of FIG. 4;

FIG. 6 is a perspective view illustrating another embodiment of a folded state of a display device;

FIG. 7 is a cross-sectional view, taken along line X3-X3′, of the display device of FIG. 6;

FIG. 8 is an enlarged cross-sectional view of portion B3 in FIG. 7;

FIG. 9 is a perspective view illustrating another embodiment of a folded state of a display device;

FIG. 10 is a cross-sectional view, taken along line X5-X5′, of the display device of FIG. 9;

FIG. 11 is a perspective view illustrating a folded state of the display device of FIG. 9;

FIG. 12 is a cross-sectional view taken along line X7-X7′ of FIG. 9;

FIG. 13 is an enlarged cross-sectional view of portion B5 in FIG. 12;

FIG. 14 is a cross-sectional view illustrating a modification of FIG. 13;

FIG. 15 is a perspective view illustrating another embodiment of a folded state of a display device;

FIG. 16 is a cross-sectional view, taken along line X9-X9′, of the display device of FIG. 15;

FIG. 17 is an enlarged cross-sectional view of portion B7 in FIG. 16;

FIG. 18 is a perspective view of another embodiment of a display device;

FIG. 19 is a perspective view illustrating a folded state of the display device of FIG. 18;

FIG. 20 is a cross-sectional view, taken along line X11-X11′, of the display device of

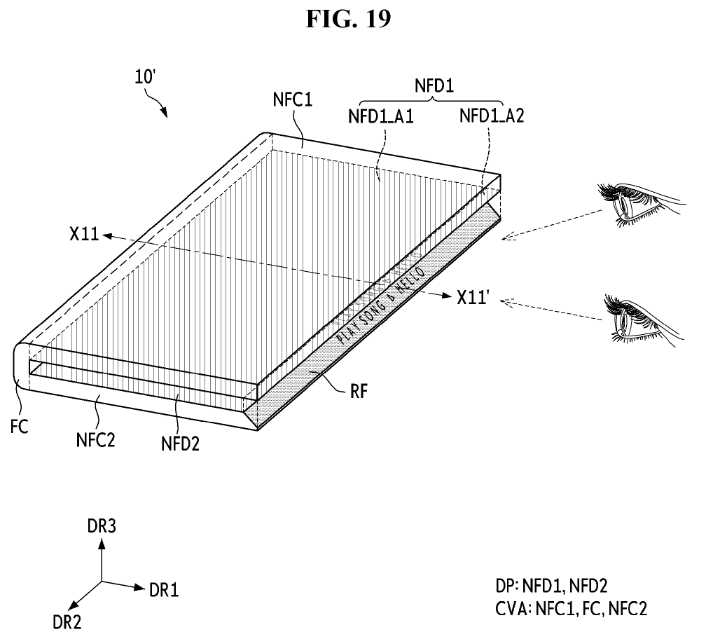

FIG. 19;

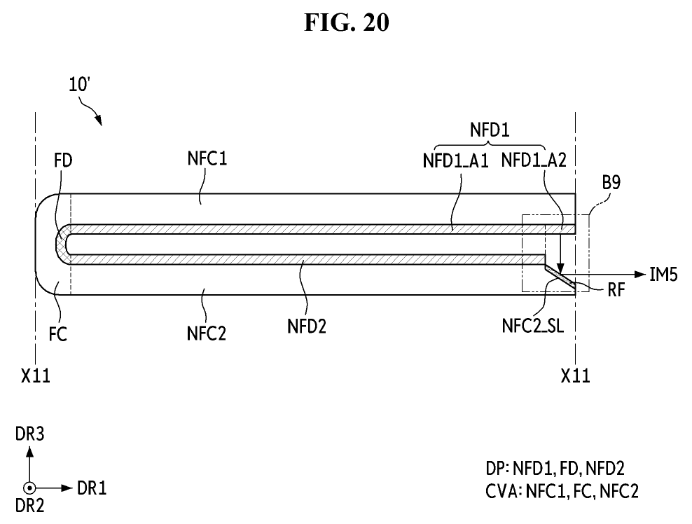

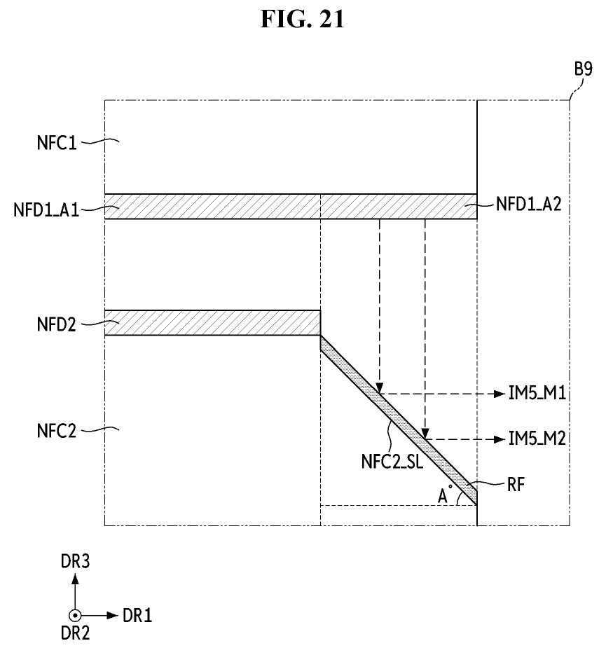

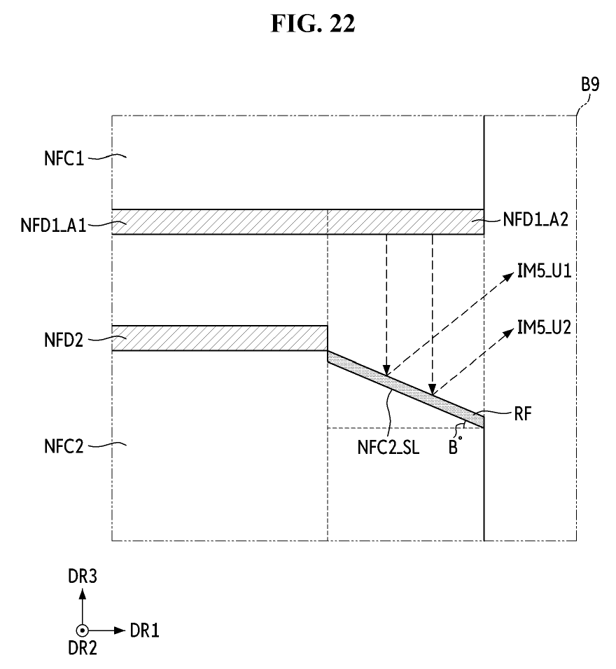

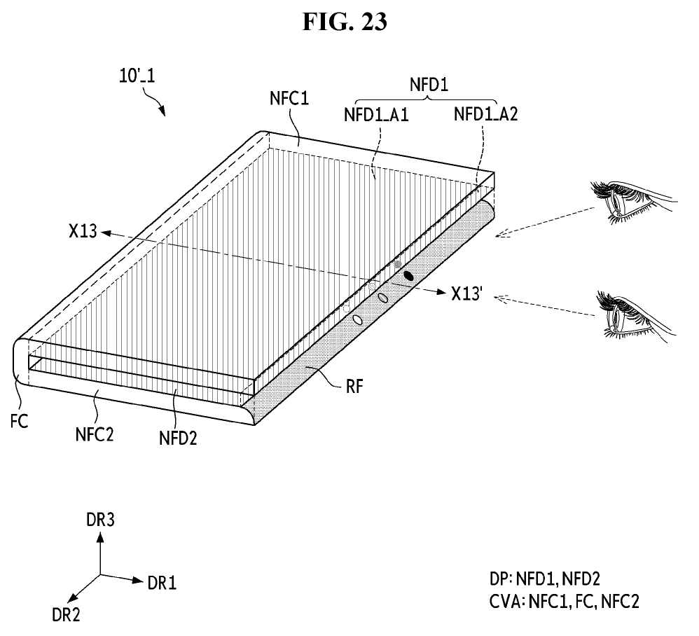

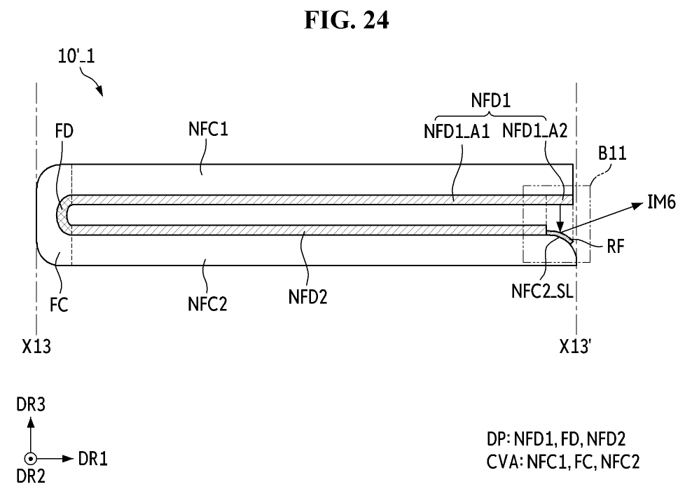

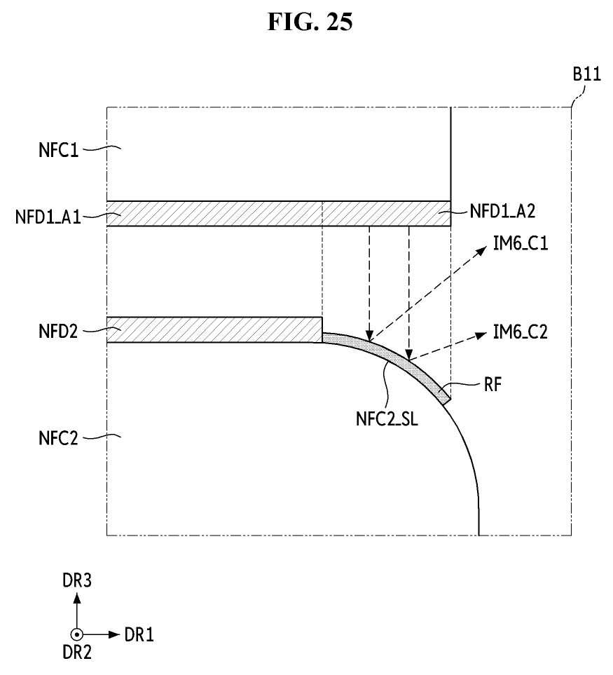

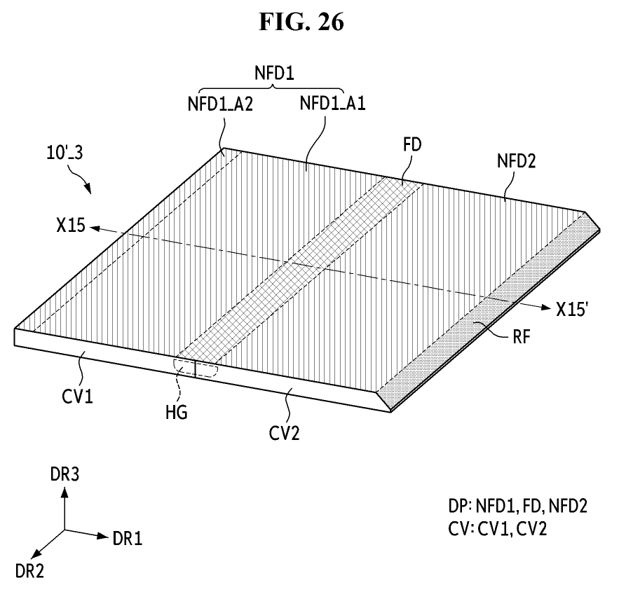

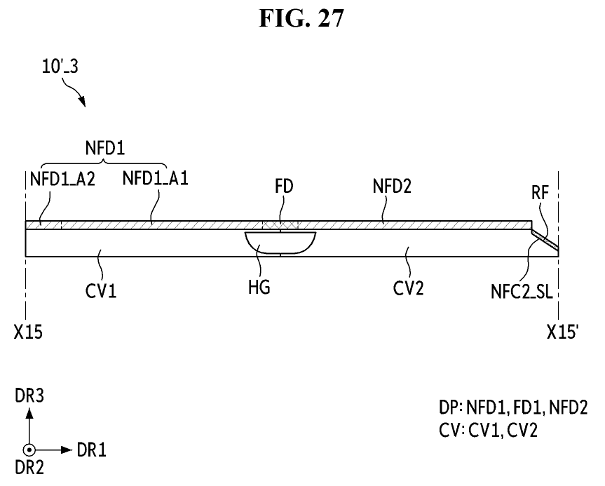

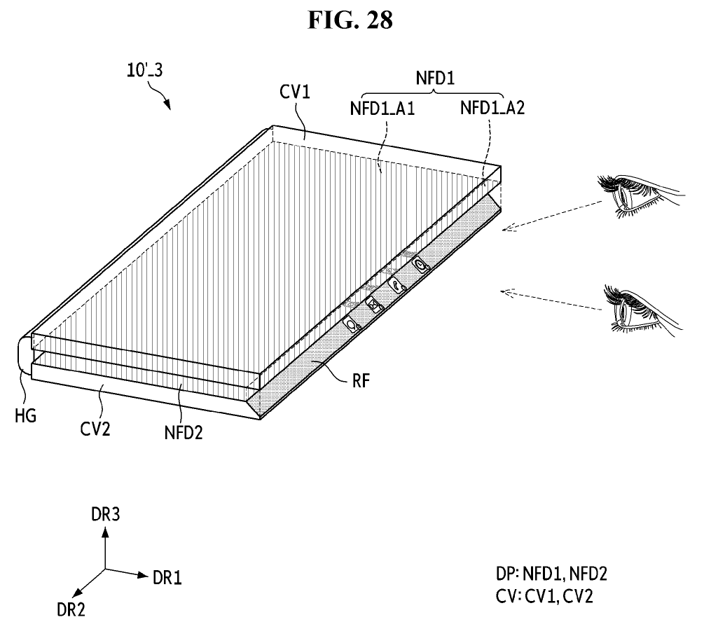

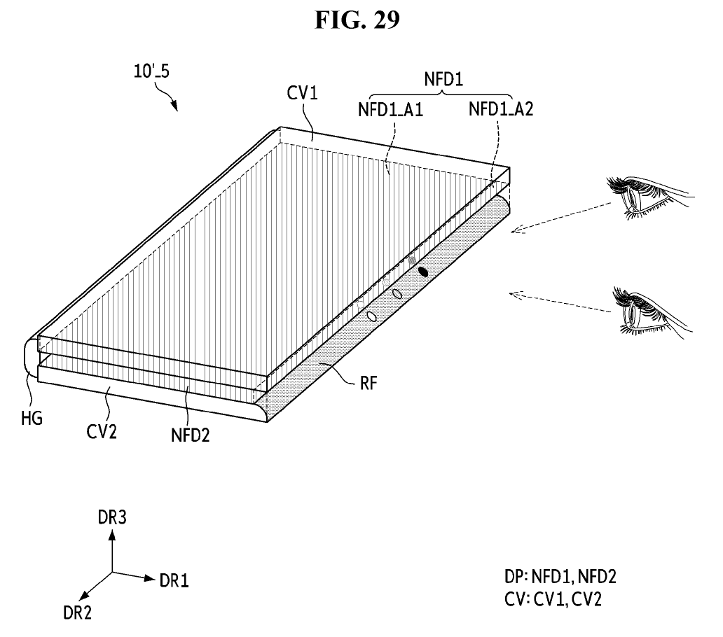

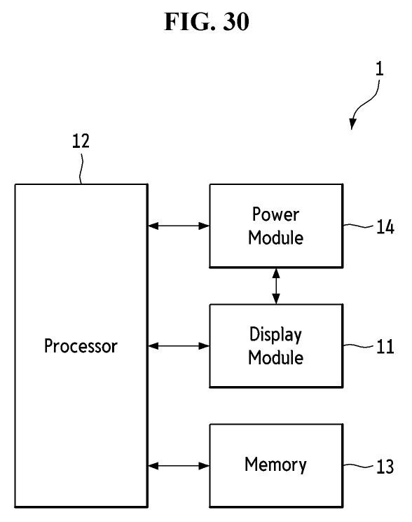

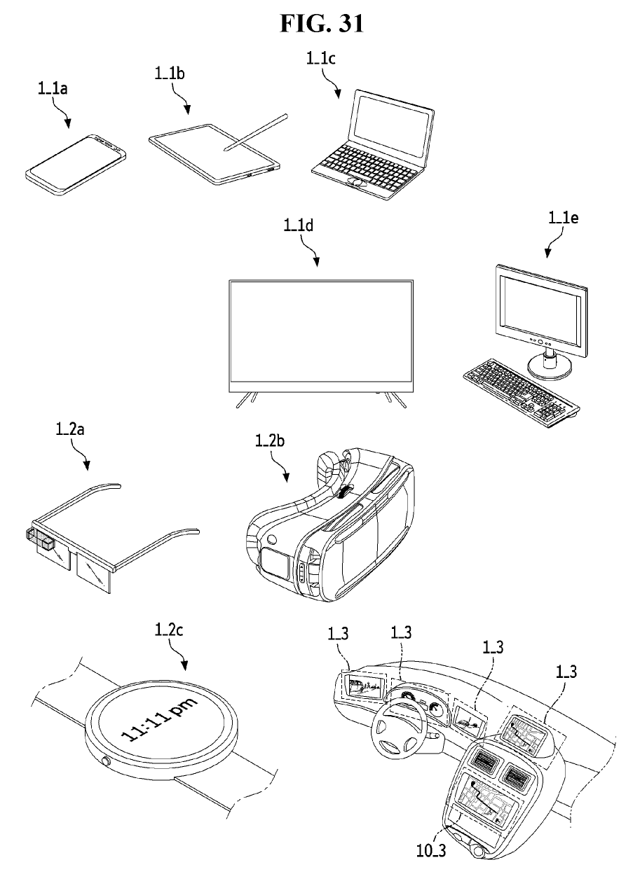

FIG. 21 is an enlarged cross-sectional view of portion B9 in FIG. 20;

FIG. 22 is a cross-sectional view illustrating a modification of FIG. 21;

FIG. 23 is a perspective view illustrating another embodiment of a folded state of a display device;

FIG. 24 is a cross-sectional view, taken along line X13-X13′, of the display device of FIG. 23;

FIG. 25 is an enlarged cross-sectional view of portion B11 in FIG. 24;

FIG. 26 is a perspective view of another embodiment of a display device;

FIG. 27 is a cross-sectional view taken along line X15-X15′ of FIG. 26;

FIG. 28 is a perspective view illustrating a folded state of the display device of FIG. 26;

FIG. 29 is a perspective view illustrating another embodiment of a folded state of a display device;

FIG. 30 is a block diagram of an embodiment of an electronic device; and

FIG. 31 shows schematic views of embodiments of electronic devices.

### DETAILED DESCRIPTION

The disclosure will now be described more fully hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being "on" another layer or substrate, it may be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

Each of the features of the embodiments of the disclosure may be combined or combined with each other, in part or in whole, and technically various interlocking and driving are possible. Each embodiment may be implemented independently of each other or may be implemented together in an association.

Hereinafter, embodiments of the disclosure will be described in detail with reference to the accompanying drawings.

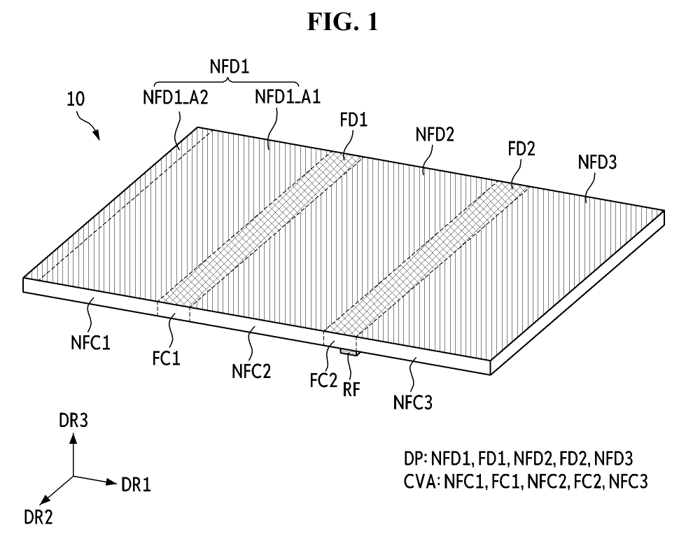

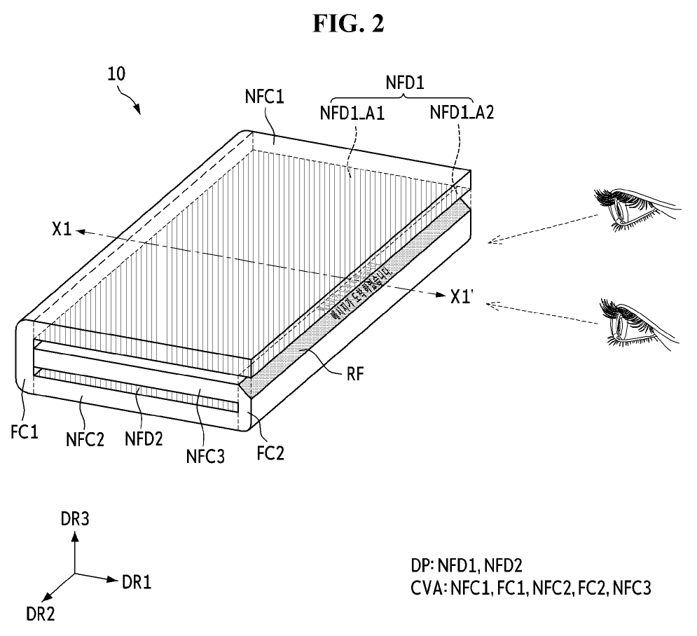

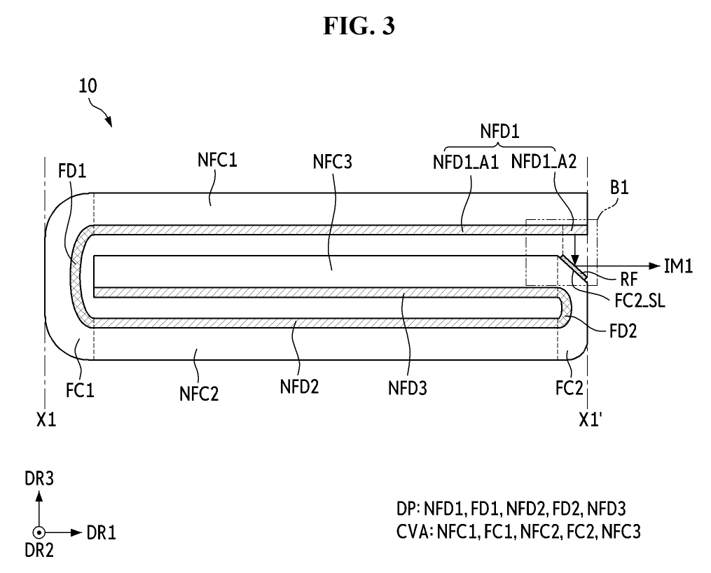

FIG. 1 is a perspective view of an embodiment of a display device. FIG. 2 is a perspective view illustrating a folded state of the display device of FIG. 1. FIG. 3 is a cross-sectional view, taken along line X1-X1′, of the display device of FIG. 2.

Referring to FIGS. 1 through 3, a display device 10 in an embodiment may be a foldable device. In this specification, the term “foldable device” refers to a device that may be folded, and encompasses not only a device that is currently folded but also a device that may have both a folded state and an unfolded state. For convenience of description, the display device 10 will hereinafter be described based on its unfolded state.

The display device 10 may have a planar quadrangular shape, e.g., rectangular shape. The display device 10 may include long sides extending in a first direction DR1 and short sides extending in a second direction DR2. In this specification, the first direction DR1 may refer to a direction parallel to the long sides of the display device 10 in a plan view, e.g., a horizontal direction of the display device 10. The second direction DR2 may refer to a direction parallel to the short sides of the display device 10 in a plan view, e.g., a vertical direction of the display device 10. A third direction DR3 may refer to a thickness direction of the display device 10.

The display device 10 may include a cover structure CVA, a display panel DP, and a reflective member RF.

The cover structure CVA may be disposed below the display panel DP and may serve to support and protect the display panel DP. The cover structure CVA may include a recess for receiving the display panel DP.

The cover structure CVA may include a first non-folding cover portion NFC1, a second non-folding cover portion NFC2, and a third non-folding cover portion NFC3 that are arranged in the first direction DR1, a first folding cover portion FC1 that is disposed between the first and second non-folding cover portions NFC1 and NFC2, and a second folding cover portion FC2 that is disposed between the second and third non-folding cover portions NFC2 and NFC3.

The display device 10 may be folded and unfolded with respect to the first and second folding cover portions FC1 and FC2 of the cover structure CVA. The first and second folding cover portions FC1 and FC2 of the cover structure CVA may each be folded in an in-folding manner toward the second non-folding cover portion NFC2 in the first direction DR1. The first and second folding cover portions FC1 and FC2 may be folded in a shape to be bent at their outer edges.

The second folding cover portion FC2 may be folded to have an inclined surface FC2_SL around the third non-folding cover portion NFC3. In an embodiment, the inclined surface FC2_SL of the second folding cover portion FC2 may be planar. When the inclined surface FC2_SL of the second folding cover portion FC2 is planar, the inclination of the inclined surface FC2_SL may be in the range of 20° to 70°. In an alternative embodiment, the inclined surface FC2_SL of the second folding cover portion FC2 may be curved.

When the first and second folding cover portions FC1 and FC2 are folded, the third non-folding cover portion NFC3 may be disposed on the second non-folding cover portion NFC2, the first non-folding cover portion NFC1 may be disposed on the third non-folding cover portion NFC3, the first folding cover portion FC1 may be disposed outside the first and second non-folding cover portions NFC1 and NFC2, and the second folding cover portion FC2 may be disposed outside the second and third non-folding cover portions NFC2 and NFC3.

The display panel DP may be disposed on the cover structure CVA. The display panel DP may be seated on the recess of the cover structure CVA.

The display panel DP may include first, second, and third non-folding portions NFD1, NFD2, and NFD3 that are arranged in the first direction DR1 and overlap the first, second, and third non-folding cover portions NFC1, NFC2, and NFC3, respectively, of the cover structure CVA, a first folding portion FD1 that is disposed between the first and second non-folding portions NFD1 and NFD2 and overlaps the first folding cover portion FC1 of the cover structure CVA, and a second folding portion FD2 that is disposed between the second and third non-folding portions NFD2 and NFD3 and overlaps the second folding cover portion FC2 of the cover structure CVA. The first non-folding portion NFD1 may include a main area NFD1_A1 that is disposed outside the first folding portion FD1 and an edge area NFD1_A2 that is disposed outside the main area NFD1_A1. When the display device 10 is folded, the main area NFD1_A1 of the first non-folding portion NFD1 may not display an image, and only the edge area NFD1_A2 of the first non-folding portion NFD1 may display an image.

The display panel DP may be folded and unfolded as the cover structure CVA is folded and unfolded. The first and second folding portions FD1 and FD2 of the display panel DP may be folded and unfolded by the first and second folding cover portions FC1 and FC2 of the cover structure CVA. The first and second folding portions FD1 and FD2 of the display panel DP may be folded in an in-folding manner toward the second non-folding portion NFD2 in the first direction DR1 by the first and second folding cover portions FC1 and FC2 of the cover structure CVA.

When the first and second folding portions FD1 and FD2 are folded, the third non-folding portion NFD3 may be disposed on the second non-folding portion NFD2, the first non-folding portion NFD1 may be disposed on the third non-folding portion NFD3, the first folding portion FD1 may be disposed outside the first and second non-folding portions NFD1 and NFD2, and the second folding portion FD2 may be disposed outside the second and third non-folding portions NFD2 and NFD3.

The reflective member RF may be disposed on a surface of the second folding cover portion FC2 of the cover structure CVA that is opposite to the surface facing the display panel DP. When the second folding cover portion FC2 of the cover structure CVA is folded, the reflective member RF may overlap the inclined surface FC2_SL of the second folding cover portion FC2. The reflective member RF may have a shape corresponding to the shape of the inclined surface FC2_SL of the second folding cover portion FC2.

The reflective member RF may serve to reflect images displayed by the display panel DP in the folded state of the display device 10 and provide the images to the outside of the display device 10. In an embodiment, the reflective member RF may include a metallic material such as chromium (Cr) or aluminum (Al). In an alternative embodiment, in embodiments, the reflective member RF may be a reflective film including a non-metallic material. In an alternative embodiment, in embodiments, the reflective member RF may be a mirror including glass.

As depicted in FIGS. 2 and 3, the display device 10 may have a structure that is folded into a “G” shape so that the display screen is not externally exposed. When the display device 10 is folded, the cover structure CVA may be disposed on a surface of the display panel DP that is opposite to the surface displaying an image, and may overlap the display panel DP. Specifically, the second non-folding portion NFD2 of the display panel DP may be disposed on the second non-folding cover portion NFC2 of the cover structure CVA, the third non-folding portion NFD3 may be disposed on the second non-folding portion NFD2, the third non-folding cover portion NFC3 of the cover structure CVA may be disposed on the third non-folding portion NFD3, the first non-folding portion NFD1 of the display panel may be disposed on the third non-folding cover portion NFC3, the first non-folding cover portion NFC1 of the cover structure CVA may be disposed on the first non-folding portion NFD1, the first folding cover portion FC1 of the cover structure CVA may be disposed outside the first folding portion FD1 of the display panel DP, and the second folding cover portion FC2 of the cover structure CVA may be disposed outside the second folding portion FD2 of the display panel DP. Accordingly, in the folded state of the display device 10, the display panel DP may be covered by the cover structure CVA and may not be exposed to the exterior in appearance.

When the display device 10 is folded, the edge area NFD1_A2 of the first non-folding portion NFD1 of the display panel DP may overlap the reflective member RF disposed on the second folding cover portion FC2 of the cover structure CVA. As the edge area NFD1_A2 of the first non-folding portion NFD1 of the display panel DP overlaps the reflective member RF when the display device 10 is folded, an image IM1 displayed by the edge area NFD1_A2 of the first non-folding portion NFD1 of the display panel DP may be reflected by the reflective member RF and provided to the outside of the display device 10. Accordingly, even in the folded state in which the display panel DP is not exposed to the outside, the display device 10 may provide notification images such as time, messages, and emails to a user without including a separate display panel on the exterior.

In an embodiment, when the display device 10 is folded, the screen refresh rate in the edge area NFD1_A2 of the first non-folding portion NFD1 of the display panel DP may be 1 Hz or less. Therefore, notification images displayed by the edge area NFD1_A2 of the first non-folding portion NFD1 may be provided to the outside of the display device 10 via the reflective member RF with low-power driving.

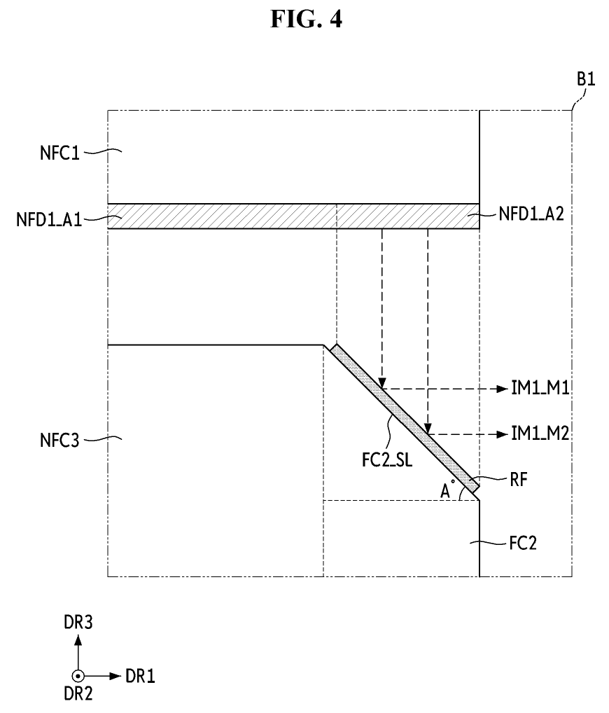

FIG. 4 is an enlarged cross-sectional view of portion B1 in FIG. 3.

Referring to FIG. 4, the inclined surface FC2_SL of the second folding cover portion FC2 of the cover structure CVA may be planar and may be folded to have a first inclination angle Aº with reference to a horizontal direction. As the inclined surface FC2_SL of the second folding cover portion FC2 of the cover structure CVA is folded to have the first inclination angle Aº, images IM1_M1 and IM1_M2 displayed by the edge area NFD1_A2 of the first non-folding portion NFD1 of the display panel DP may be reflected by the reflective member RF on the inclined surface FC2_SL of the second folding cover portion FC2 and provided to the outside of the display device 10 in the first direction DR1. Accordingly, as illustrated in FIG. 2, notification images such as time, messages, and emails displayed in the edge area NFD1_A2 of the first non-folding portion NFD1 of the display panel DP may be reflected by the reflective member RF and visually recognized by the user in the first direction DR1.

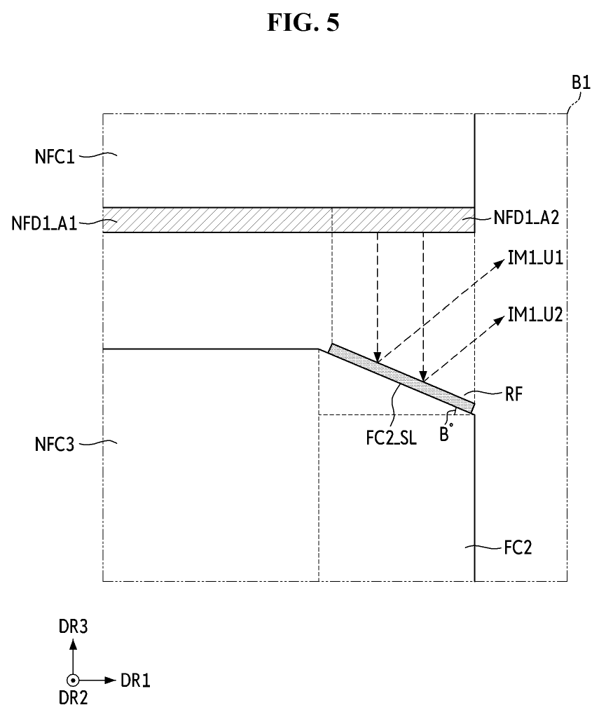

FIG. 5 is a cross-sectional view illustrating a modification of FIG. 4.

The following description focuses mainly on differences from the embodiment of FIG. 4, and repeated descriptions will be omitted.

Referring to FIG. 5, as compared with FIG. 4, an inclined surface FC2_SL of a second folding cover portion FC2 of a cover structure CVA may be folded to have a second inclination angle Bº, which is smaller than the first inclination angle Aº, with reference to a horizontal direction. As the inclined surface FC2_SL of the second folding cover portion FC2 of the cover structure CVA has the second inclination angle Bº smaller than the first inclination angle Aº, images IM1_U1 and IM1_U2 displayed by an edge area NFD1_A2 of a first non-folding portion NFD1 of a display panel DP may be reflected by a reflective member RF disposed on the inclined surface FC2_SL of the second folding cover portion FC2 and provided to the outside of a display device 10 in a direction inclined from the first direction DR1 toward the third direction DR3. Accordingly, as illustrated in FIG. 2, notification images such as time, messages, and emails displayed in an edge area NFD1_A2 of a first non-folding portion NFD1 of the display panel DP may be reflected by the reflective member RF and visually recognized by the user in a direction inclined from the first direction DR1 toward the third direction DR3.

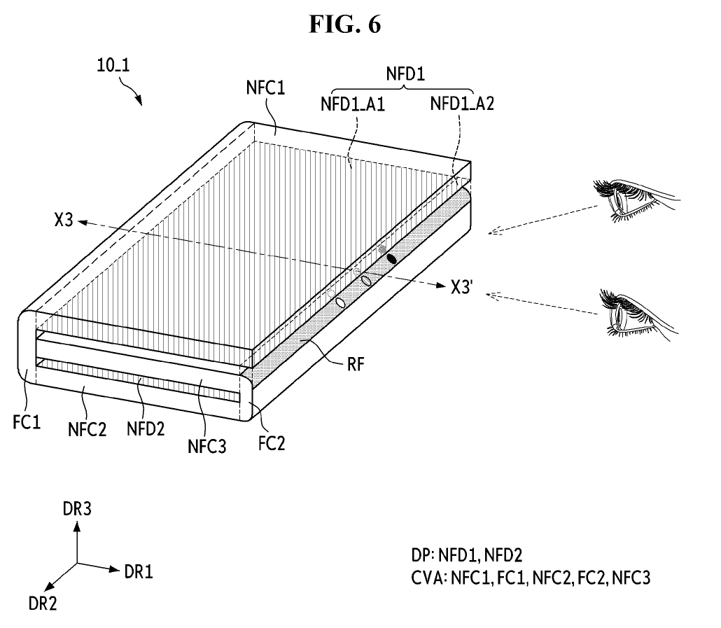

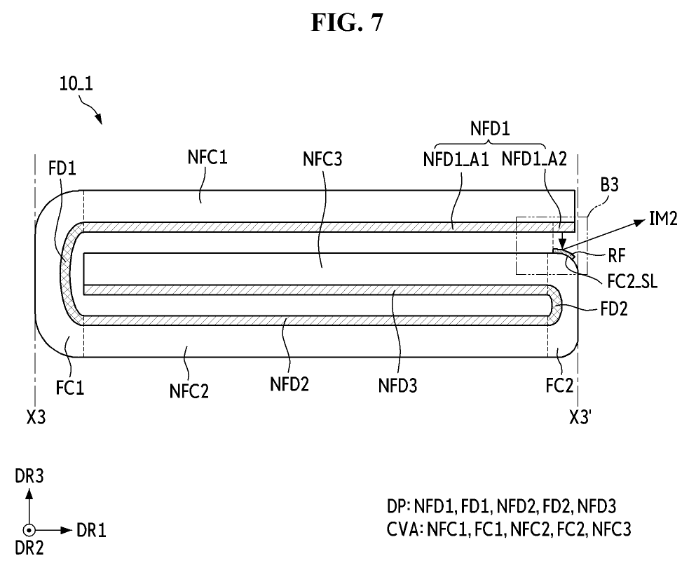

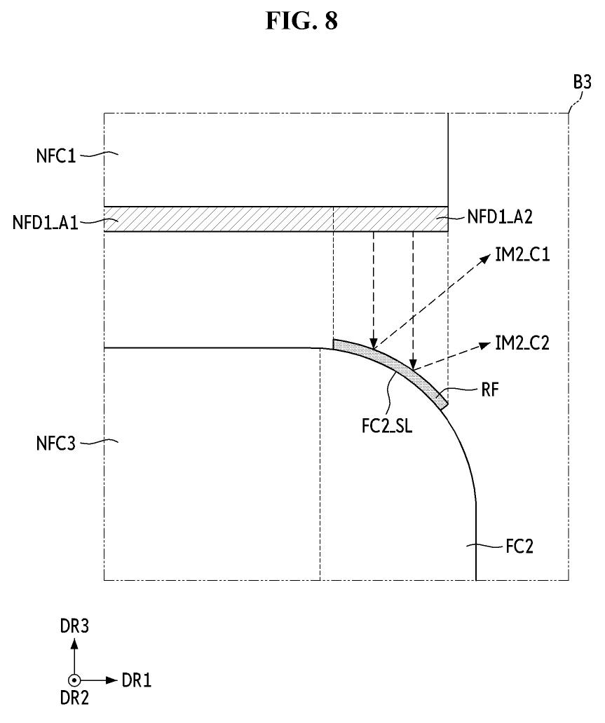

FIG. 6 is a perspective view illustrating another embodiment of a folded state of a display device. FIG. 7 is a cross-sectional view, taken along line X3-X3', of the display device of FIG. 6. FIG. 8 is an enlarged cross-sectional view of portion B3 in FIG. 7.

The following description focuses mainly on differences from the embodiments of FIGS. 2, 3, and 5, and repeated descriptions will be omitted.

Referring to FIGS. 6 through 8, as compared with FIGS. 2, 3, and FIGS. 5, an inclined surface FC2_SL of a second folding cover portion FC2 of a cover structure CVA may be curved. A reflective member RF may have a curved shape corresponding to the shape of the inclined surface FC2_SL of the second folding cover portion FC2. In the folded state of a display device 10_1, an image IM2 displayed by an edge area NFD1_A2 of a first non-folding portion NFD1 of a display panel DP may be reflected by the reflective member RF and provided to the outside of the display device 10_1. Images IM2_C1 and IM2_C2 displayed by an edge area NFD1_A2 of the first non-folding portion NFD1 may be reflected by the reflective member RF and provided to the outside in a direction inclined from the first direction DR1 toward the third direction DR3. In an embodiment, images IM2_C1 and IM2_C2 displayed by the edge area NFD1_A2 of the first non-folding portion NFD1 may be distorted due to the curvature of the reflective member RF. Accordingly, as illustrated in FIG. 6, when the reflective member RF has a curved shape, the images IM2_C1 and IM2_C2 displayed by the edge area NFD1_A2 of the first non-folding portion NFD1 may be notification images in the form of relatively small dots representing different colors. In an alternative embodiment, in embodiments, the images IM2_C1 and IM2_C2 displayed by the edge area NFD1_A2 of the first non-folding portion NFD1 may be images adjusted to prevent distortion when viewed from the outside.

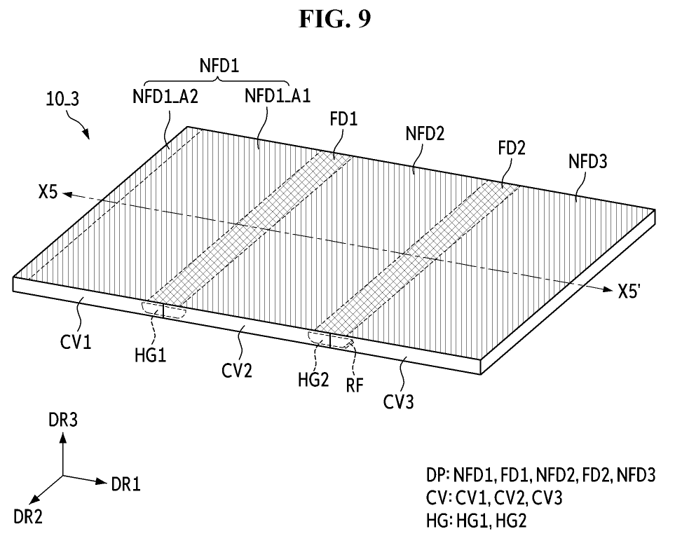

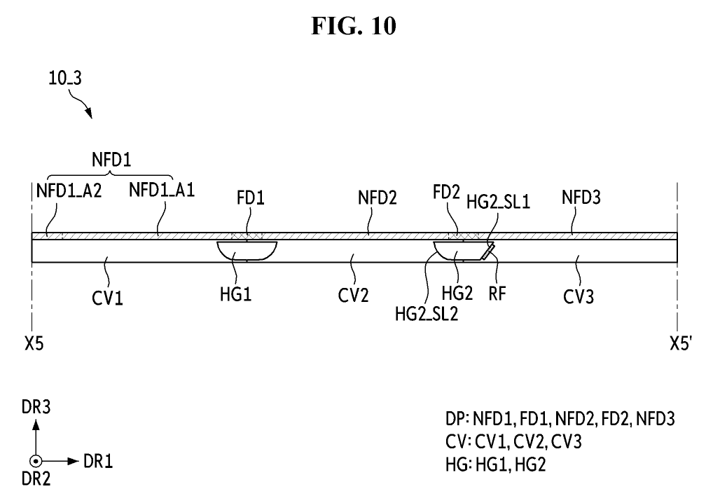

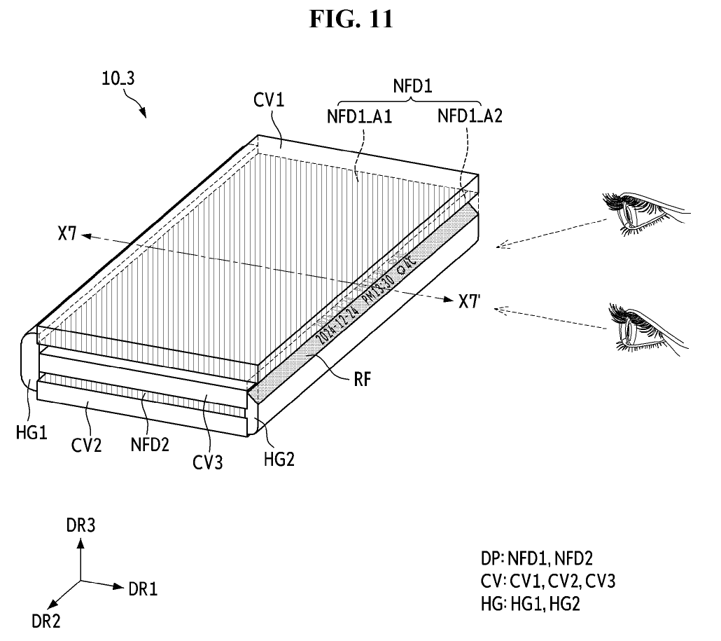

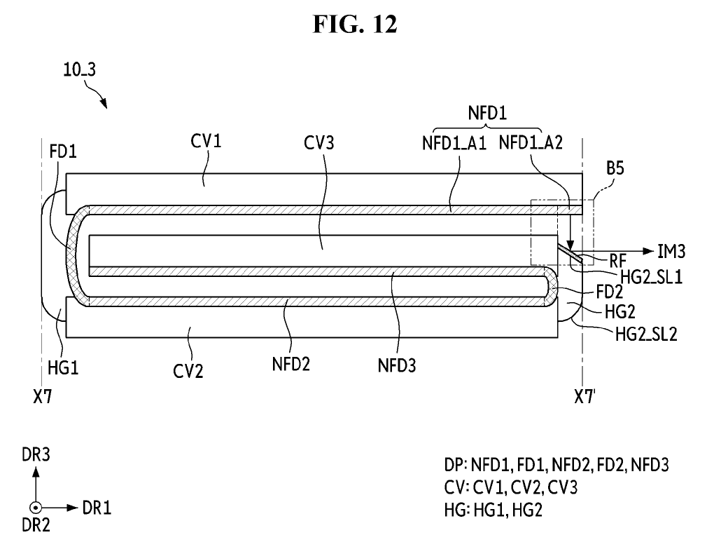

FIG. 9 is a perspective view illustrating another embodiment of a folded state of a display device. FIG. 10 is a cross-sectional view, taken along line X5-X5’, of the display device of FIG. 9. FIG. 11 is a perspective view illustrating a folded state of the display device of FIG. 9. FIG. 12 is a cross-sectional view, taken along line X7-X7’, of the display device of FIG. 9.

Referring to FIGS. 9 and 10, a display device 10_3 may include a display panel DP, a cover member CV, a hinge member HG, and a reflective member RF.

The cover member CV may be disposed below the display panel DP and may serve to support and protect the display panel DP. The cover member CV may include a recess for receiving the display panel DP and the hinge member HG. The cover member CV may include a first cover member CV1, a second cover member CV2, and a third cover member CV3 that are arranged in the first direction DR1.

The display panel DP may be disposed on the cover member CV. The display panel DP may be seated on the recess of the cover member CV. The display panel DP may be arranged in the first direction DR1 and may include first, second, and third non-folding portions NFD1, NFD2, and NFD3 overlapping the first, second, and third cover members CV1, CV2, and CV3, respectively, of the cover member CV, a first folding portion FD1 disposed between the first and second non-folding portions NFD1 and NFD2, and a second folding portion FD2 disposed between the second and third non-folding portions NFD2 and NFD3. The first non-folding portion NFD1 may include a main area NFD1_A1 disposed outside the first folding portion FD1 and an edge area NFD1_A2 disposed outside the main area NFD1_A1. When the display device 10_3 is folded, the main area NFD1_A1 of the first non-folding portion NFD1 may not display an image, and only the edge area NFD1_A2 of the first non-folding portion NFD1 may display an image.

The hinge member HG may be disposed inside the cover member CV and may be connected to the cover member CV to function as a folding axis around which to rotate the cover member CV. As illustrated in FIGS. 9 and 10, the hinge member HG may not be exposed to the outside in the unfolded state due to being covered by the cover member CV. The hinge member HG may include a first hinge member HG1 that overlaps the first folding portion FD1 of the display panel DP and connects the first and second cover members CV1 and CV2, and a second hinge member HG2 that overlaps the second folding portion FD2 and connects the second and third cover members CV2 and CV3.

A surface of the second hinge member HG2 that is opposite to the surface facing the display panel DP may include a first inclined surface HG2_SL1 overlapping the third cover member CV3 and a second inclined surface HG2_SL2 overlapping the second cover member CV2. In an embodiment, the first inclined surface HG2_SL1 of the second hinge member HG2 may be planar. When the first inclined surface HG2_SL1 of the second hinge member HG2 is planar, the inclination of the first inclined surface HG2_SL1 may be in the range of 20° to 70°. In an alternative embodiment, in embodiments, the first inclined surface HG2_SL1 of the second hinge member HG2 may be curved.

In an embodiment, the shape of the first inclined surface HG2_SL1 of the second hinge member HG2 may be different from the shape of the second inclined surface HG2_SL2 of the second hinge member HG2. In an alternative embodiment, in embodiments, the shape of the first inclined surface HG2_SL1 of the second hinge member HG2 may be the same as the shape of the second inclined surface HG2_SL2 of the second hinge member HG2.

The reflective member RF may be disposed on a surface of the second hinge member HG2 that is opposite to the surface facing the display panel DP. The reflective member RF may overlap the first inclined surface HG2_SL1 of the second hinge member HG2. The reflective member RF may have a shape corresponding to the inclined surface HG2_SL1 of the second hinge member HG2.

The reflective member RF may serve to reflect images displayed by the display panel DP in the folded state of the display device 10_3 and provide the images to the outside. In an embodiment, the reflective member RF may include a reflective metallic material such as Cr or Al. In an alternative embodiment, in embodiments, the reflective member RF may be a reflective film including a non-metallic material. In an alternative embodiment, in embodiments, the reflective member RF may be a mirror including glass.

Referring to FIGS. 11 and 12, the cover member CV may rotate about the hinge member HG as its folding axis. In the folded state of the display device 10_3, the third cover member CV3 may be disposed on the second cover member CV2, the first cover member CV1 may be disposed on the third cover member CV3, a portion of the first hinge member HG1 may be exposed to the outside between the first and third cover members CV1 and CV3 and may be disposed outside the first and third cover members CV1 and CV3, and a portion of the second hinge member HG2 may be exposed to the outside between the second and third cover members CV2 and CV3 and may be disposed outside the second and third cover members CV2 and CV3. In addition, in the folded state of the display device 10_3, portions of the first and second inclined surfaces HG2_SL1 and HG2_SL2 of the second hinge member HG2 and the reflective member RF may be exposed to the outside of the cover member CV.

The first and second folding portions FD1 and FD2 of the display panel DP may be folded and unfolded by the first and second hinge members HG1 and HG2, respectively. The first and second folding portions FD1 and FD2 of the display panel DP may be folded in an in-folding manner toward the second non-folding portion NFD2 in the first direction DR1 by the first and second hinge members HG1 and HG2. When the first and second folding portions FD1 and FD2 are folded, the third non-folding portion NFD3 may be disposed on the second non-folding portion NFD2, the first non-folding portion NFD1 may be disposed on the third non-folding portion NFD3, the first folding portion FD1 may be disposed outside the first and second non-folding portions NFD1 and NFD2, and the second folding portion FD2 may be disposed outside the second and third non-folding portions NFD2 and NFD3.

As illustrated in FIGS. 11 and 12, the display device 10_3 may have a structure folded into a “G” shape so that the display screen is not externally exposed. When the display device 10_3 is folded, the cover member CV and the hinge member HG may be disposed on a surface of the display panel DP opposite to the image display surface of the display panel DP, and may overlap the display panel DP. Specifically, the second non-folding portion NFD2 may be disposed on the second cover member CV2, the third non-folding portion NFD3 may be disposed on the second non-folding portion NFD2, the third cover member CV3 may be disposed on the third non-folding portion NFD3, the first non-folding portion NFD1 may be disposed on the third cover member CV3, the first cover member CV1 may be disposed on the first non-folding portion NFD1, the first hinge member HG1 may be disposed outside the first folding portion FD1 of the display panel DP, and the second hinge member HG2 may be disposed outside the second folding portion FD2 of the display panel DP. Accordingly, in the folded state of the display device 10_3, the display panel DP may be covered by the cover member CV and the hinge member HG and may not be exposed to the exterior in appearance.

When the display device 10_3 is folded, the edge area NFD1_A2 of the first non-folding portion NFD1 of the display panel DP may overlap the reflective member RF disposed on the first inclined surface HG2_SL1 of the second hinge member HG2. As the edge area NFD1_A2 of the first non-folding portion NFD1 of the display panel DP overlaps the reflective member RF when the display device 10_3 is folded, an image IM3 displayed by the edge area NFD1_A2 of the first non-folding portion NFD1 may be reflected by the reflective member RF and provided to the outside of the display device 10_3. Accordingly, the display device 10_3 may provide notification images such as time, messages, and emails to a user even in the folded state without a separate display panel on the exterior.

In an embodiment, when the display device 10_3 is folded, the screen refresh rate in the edge area NFD1_A2 of the first non-folding portion NFD1 of the display panel DP may be 1 Hz or less. Accordingly, with low-power driving, notification images displayed by the edge area NFD1_A2 of the first non-folding portion NFD1 may be provided to the outside of the display device 10_3 via the reflective member RF.

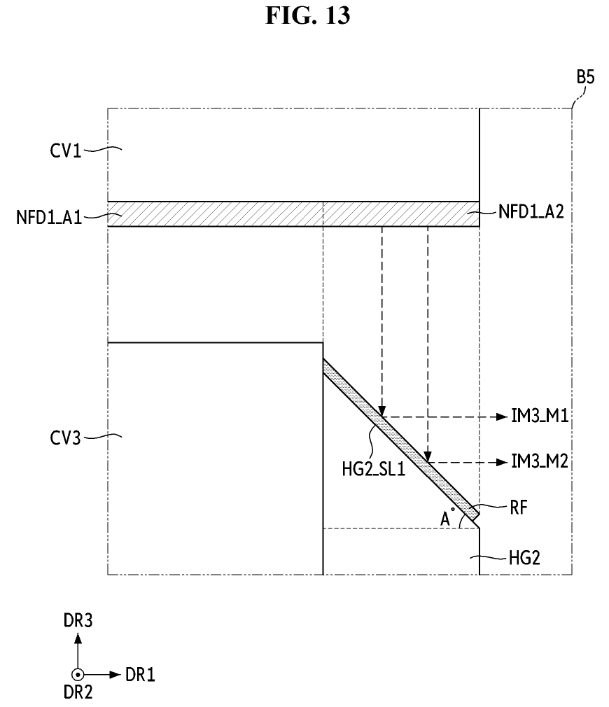

FIG. 13 is an enlarged cross-sectional view of portion B5 in FIG. 12.

Referring to FIG. 13, the first inclined surface HG2_SL1 of the second hinge member HG2 may be planar and may have a first inclination angle Aº with reference to a horizontal direction. As the first inclined surface HG2_SL1 of the second hinge member HG2 has the first inclination angle Aº, images IM3_M1 and IM3_M2 displayed by the edge area NFD1_A2 of the first non-folding portion NFD1 of the display panel DP may be reflected by the reflective member RF disposed on the first inclined surface HG2_SL1 of the second hinge member HG2 and provided to the outside of the display device 10_3 in the first direction DR1. Accordingly, as illustrated in FIG. 11, notification images such as time, messages, and emails displayed in the edge area NFD1_A2 of the first non-folding portion NFD1 of the display panel DP may be reflected by the reflective member RF and visually recognized by the user in the first direction DR1.

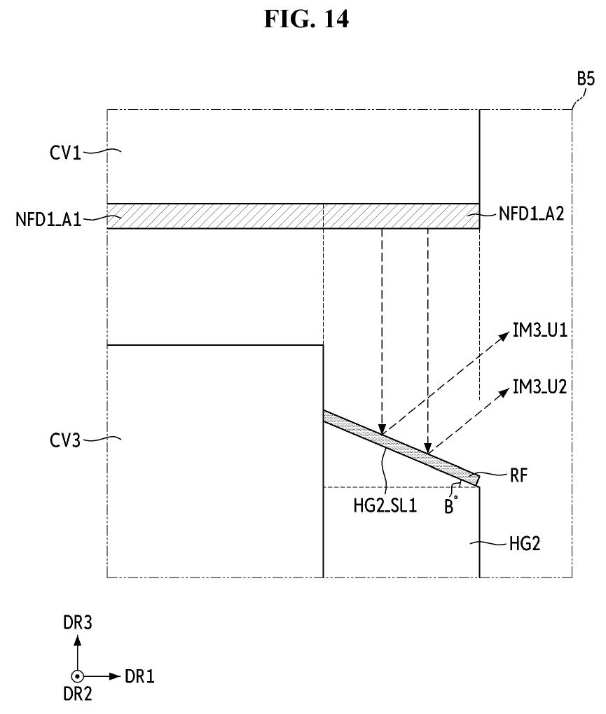

FIG. 14 is a cross-sectional view illustrating a modification of FIG. 13.

The following description focuses mainly on differences from the embodiment of FIG. 4, and repeated descriptions will be omitted.

Referring to FIG. 14, as compared with FIG. 4, the first inclined surface HG2_SL1 of the second hinge member HG2 may have a second inclination angle Bº, which is smaller than the first inclination angle Aº, with reference to a horizontal direction. As the first inclined surface HG2_SL1 of the second hinge member HG2 has the second inclination angle Bº smaller than the first inclination angle Aº, images IM3_U1 and IM3_U2 displayed by the edge area NFD1_A2 of the first non-folding portion NFD1 of the display panel DP may be reflected by the reflective member RF disposed on the first inclined surface HG2_SL1 of the second hinge member HG2 and provided to the outside of the display device 10_3 in a direction inclined from the first direction DR1 toward the third direction DR3. Accordingly, as illustrated in FIG. 11, notification images such as time, messages, and emails displayed in the edge area NFD1_A2 of the first non-folding portion NFD1 of the display panel DP may be reflected by the reflective member RF and visually recognized by the user in a direction inclined from the first direction DR1 toward the third direction DR3.

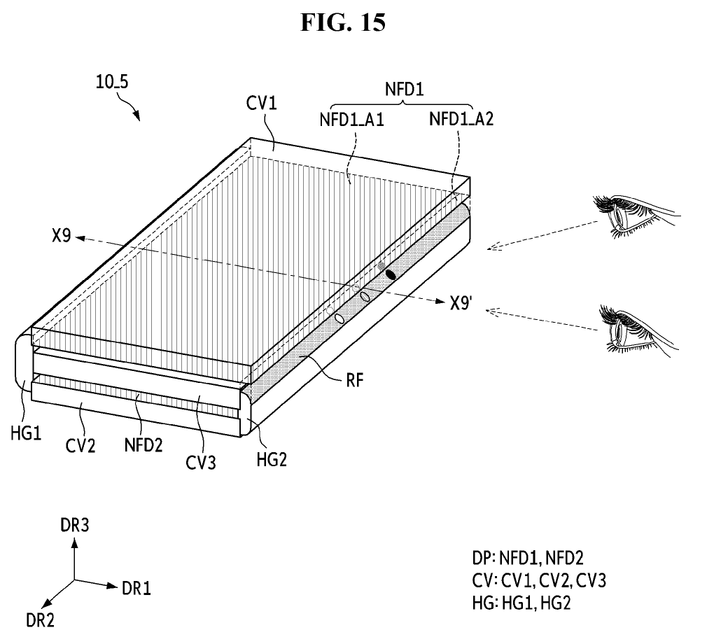

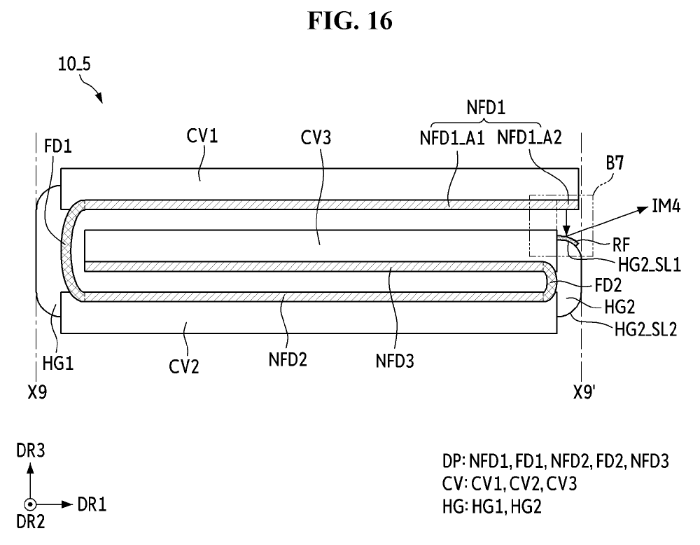

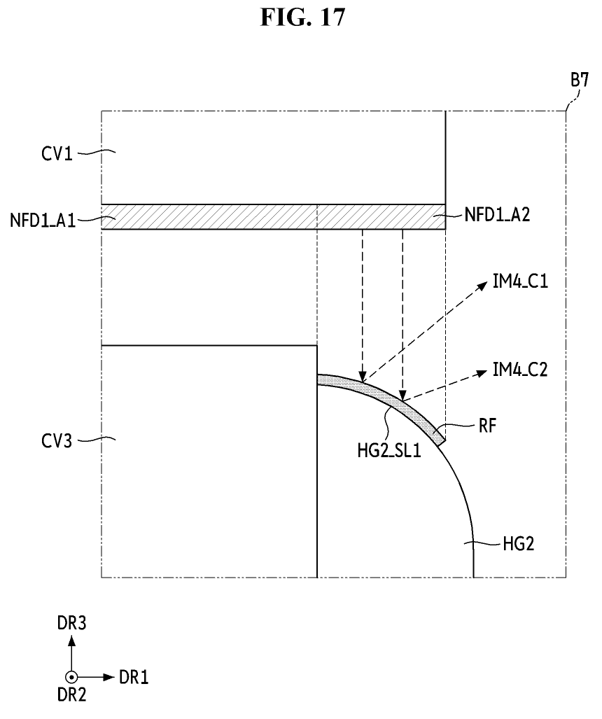

FIG. 15 is a perspective view illustrating another embodiment of a folded state of a display device. FIG. 16 is a cross-sectional view, taken along line X9-X9’, of the display device of FIG. 15. FIG. 17 is an enlarged cross-sectional view of portion B7 in FIG. 16.

The following description focuses mainly on differences from the embodiments of FIGS. 11, 12, and 14, and repeated descriptions will be omitted.

Referring to FIGS. 15 through 17, as compared with FIGS. 11, 12, and 14, a first inclined surface HG2_SL1 of a second hinge member HG2 may be curved. A reflective member RF may have a shape corresponding to the shape of the first inclined surface HG2_SL1 of the second hinge member HG2. In the folded state of a display device 10_5, an image IM4 displayed by an edge area NFD1_A2 of a first non-folding portion NFD1 of a display panel DP may be reflected by a reflective member RF with a curved shape and provided to the outside of the display device 10_5. Images IM4_C1 and IM4_C2 displayed by the edge area NFD1_A2 of the first non-folding portion NFD1 may be reflected by the reflective member RF and provided to the outside in a direction inclined from the first direction DR1 toward the third direction DR3. In an embodiment, the images IM4_C1 and IM4_C2 displayed by the edge area NFD1_A2 of the first non-folding portion NFD1 may be distorted due to the curvature of the reflective member RF. Accordingly, as illustrated in FIG. 15, when the reflective member RF has a curved shape, the images IM4_C1 and IM4_C2 displayed by the edge area NFD1_A2 of the first non-folding portion NFD1 may be notification images in the form of relatively small dots representing different colors. In an alternative embodiment, in embodiments, the images IM4_C1 and IM4_C2 displayed by the edge area NFD1_A2 of the first non-folding portion NFD1 may be images adjusted to prevent distortion when viewed from the outside.

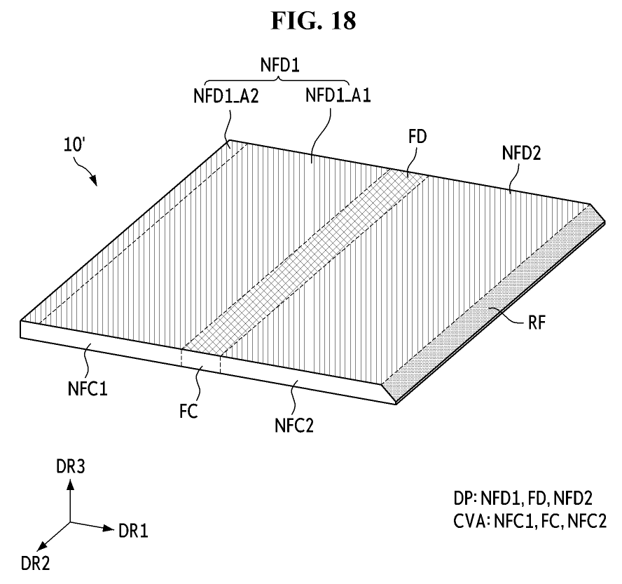

FIG. 18 is a perspective view of another embodiment of a display device. FIG. 19 is a perspective view illustrating a folded state of the display device of FIG. 18. FIG. 20 is a cross-sectional view, taken along line X11-X11’, of the display device of FIG. 19.

Referring to FIGS. 18 through 20, a display device 10′ may include a cover structure CVA, a display panel DP, and a reflective member RF.

The cover structure CVA may be disposed below the display panel DP and may serve to support and protect the display panel DP. The cover structure CVA may include a recess for receiving the display panel DP. The cover structure CVA may include a first non-folding cover portion NFC1, a second non-folding cover portion NFC2, and a folding cover portion FC disposed between the first and second non-folding cover portions NFC1 and NFC2 in the first direction DR1. The second non-folding cover portion NFC2 may be disposed at the outermost edge of the cover structure CVA and may include an inclined surface NFC2_SL that does not overlap the display panel DP.

The display device 10′ may be folded and unfolded with respect to the folding cover portion FC of the cover structure CVA. The folding cover portion FC may be folded in an in-folding manner toward the second non-folding cover portion NFC2 in the first direction DR1. The folding cover portion FC may be folded to be bent at its outer edge.

When the folding cover portion FC is folded, the first non-folding cover portion NFC1 may be disposed on the second non-folding cover portion NFC2, and the folding cover portion FC may be disposed outside the first and second non-folding cover portions NFC1 and NFC2.

The display panel DP may be disposed on the cover structure CVA. The display panel DP may be seated on the recess of the cover structure CVA. The display panel DP may be disposed in the first direction DR1 and may include first and second non-folding portions NFD1 and NFD2 overlapping the first and second non-folding cover portions NFC1 and NFC2, respectively, of the cover structure CVA, and a first folding portion FD1 disposed between the first and second non-folding portions NFD1 and NFD2 and overlapping the folding cover portion FC of the cover structure CVA.

The first non-folding portion NFD1 may include a main area NFD1_A1 disposed outside the folding portion FD and an edge area NFD1_A2 disposed outside the main area NFD1_A1. When the display device 10′ is folded, the main area NFD1_A1 of the first non-folding portion NFD1 may not display an image, and only the edge area NFD1_A2 of the first non-folding portion NFD1 may display an image.

The display panel DP may be folded and unfolded in accordance with the cover structure CVA. The folding portion FD of the display panel DP may be folded and unfolded by the folding cover portion FC of the cover structure CVA. The folding portion FD of the display panel DP may be folded in an in-folding manner toward the second non-folding portion NFD2 in the first direction DR1 by the folding cover portion FC of the cover structure CVA. When the folding portion FD is folded, the first non-folding portion NFD1 may be disposed on the second non-folding portion NFD2, and the folding portion FD may be disposed outside the first and second non-folding portions NFD1 and NFD2.

The reflective member RF may be disposed on an inclined surface NFD2_SL of the second non-folding portion NFD2 of the cover structure CVA. The reflective member RF may have a shape corresponding to the inclined surface NFD2_SL of the second non-folding portion NFD2. The reflective member RF may serve to reflect images displayed by the display panel DP in the folded state of the display device 10′ and provide the images to the outside of the display device 10′. In an embodiment, the reflective member RF may include a reflective metallic material such as Cr or Al. In an alternative embodiment, in embodiments, the reflective member RF may be a reflective film including a non-metallic material. In an alternative embodiment, in embodiments, the reflective member RF may be a mirror including glass.

As illustrated in FIG. 19, the display device 10′ may have a foldable structure folded in a “C” shape so that the display screen is not externally exposed. When the display device 10′ is folded, the cover structure CVA may be disposed on a surface of the display panel DP that is opposite to the image display surface of the display panel DP, and may overlap the display panel DP. Specifically, the second non-folding portion NFD2 of the display panel DP may be disposed on the second non-folding cover portion NFC2 of the cover structure, the first non-folding portion NFD1 may be disposed on the second non-folding portion NFD2, the first non-folding cover portion NFC1 of the cover structure CVA may be disposed on the first non-folding portion NFD1, and the folding cover portion FC of the cover structure CVA may be disposed outside the folding portion FD of the display panel DP. Accordingly, in the folded state of the display device 10′, the display panel DP may be covered by the cover structure CVA and may not be exposed to the exterior in appearance.

When the display device 10′ is folded, the edge area NFD1_A2 of the first non-folding portion NFD1 of the display panel DP may overlap the reflective member RF disposed on the inclined surface NFD2_SL of the second non-folding portion NFD2 of the cover structure CVA. As the edge area NFD1_A2 of the first non-folding portion NFD1 of the display panel DP overlaps the reflective member RF when the display device 10′ is folded, an image IM5 displayed by the edge area NFD1_A2 may be reflected by the reflective member RF and provided to the outside of the display device 10′. Accordingly, the display device 10′ may provide notification images such as time, messages, and emails to a user even in the folded state without a separate display panel on the exterior.

In an embodiment, when the display device 10′ is folded, the screen refresh rate in the edge area NFD1_A2 of the first non-folding portion NFD1 of the display panel DP may be 1 Hz or less. Accordingly, with low-power driving, notification images displayed by the edge area NFD1_A2 of the first non-folding portion NFD1 may be provided to the outside of the display device 10′ via the reflective member RF.

FIG. 21 is an enlarged cross-sectional view of portion B9 in FIG. 20.

Referring to FIG. 21, an inclined surface NFC2_SL of the second non-folding cover portion NFC2 of the cover structure CVA may be folded to be planar and have a first inclination angle Aº with reference to a horizontal direction. As the inclined surface NFC2_SL of the second non-folding cover portion NFC2 of the cover structure CVA is folded to have the first inclination angle Aº, images IM5_M1 and IM5_M2 displayed by an edge area NFD1_A2 of the first non-folding portion NFD1 of the display panel DP may be reflected by the reflective member RF disposed on the inclined surface NFC2_SL of the second non-folding cover portion NFC2 and may be provided to the outside of the display device 10′ in the first direction DR1. Accordingly, as illustrated in FIG. 19, a notification image such as time, message, or mail displayed by the edge area NFD1_A2 of the first non-folding portion NFD1 of the display panel DP may be reflected by the reflective member RF and be visible to the user in the first direction DR1.

FIG. 22 is a cross-sectional view illustrating a variation of FIG. 21.

The following description focuses mainly on differences from the embodiment of FIG. 21, and repeated descriptions will be omitted.

Referring to FIG. 22, compared to FIG. 21, the inclined surface NFC2_SL of the second non-folding cover portion NFC2 of the cover structure CVA may be folded to have a second inclination B smaller than the first inclination angle Aº with reference to a horizontal direction. As the inclined surface NFC2_SL of the second non-folding cover portion NFC2 of the cover structure CVA has the second inclination angle Bº, which is smaller than the first inclination angle Aº, with reference to a horizontal direction, images IM5_U1 and IM5_U2 displayed by the edge area NFD1_A2 of the first non-folding portion NFD1 of the display panel DP may be reflected by the reflective member RF disposed on the inclined surface NFC2_SL of the second non-folding cover portion NFC2 and may be provided to the outside of the display device 10′ in a direction inclined from the first direction DR1 toward the third direction DR3. Accordingly, as illustrated in FIG. 19, a notification image such as time, message, or mail displayed by the edge area NFD1_A2 of the first non-folding portion NFD1 of the display panel DP may be reflected by the reflective member RF and be visible to the user in a direction inclined from the first direction DR1 toward the third direction DR3.

FIG. 23 is a perspective view illustrating another embodiment of a folded state of a display device. FIG. 24 is a cross-sectional view, taken along line X13–X13’, of the display device of FIG. 23. FIG. 25 is a cross-sectional view enlarging portion B11 of FIG. 24.

The following description focuses mainly on differences from the embodiments of FIGS. 19, 20, and 22, and repeated descriptions will be omitted.

Referring to FIGS. 23 through 25, compared to FIGS. 19, 20, and 22, an inclined surface NFC2_SL of a second non-folding cover portion NFC2 of a cover structure CVA may be a curved surface. A reflective member RF may have a shape corresponding to the shape of the inclined surface NFC2_SL of the second non-folding cover portion NFC2. In a folded state of a display device 10′_1, an image IM6 displayed by an edge area NFD1_A2 of a first non-folding portion NFD1 of a display panel DP may be reflected by the reflective member RF with a curved shape and be provided to the outside of the display device 10′_1. Images IM6_C1 and IM6_C2 displayed by the edge area NFD1_A2 of the first non-folding portion NFD1 may be reflected by the reflective member RF and be provided to the outside in a direction inclined from the first direction DR1 toward the third direction DR3. In an embodiment, the images IM6_C1 and IM6_C2 displayed by the edge area NFD1_A2 of the first non-folding portion NFD1 may be distorted images according to the curvature of the reflective member RF. Accordingly, as illustrated in FIG. 23, when the reflective member RF has a curved shape, the images IM6_C1 and IM6_C2 displayed by the edge area NFD1_A2 of the first non-folding portion NFD1 may be notification images in the form of relatively small dots representing different colors. In an alternative embodiment, in embodiments, the images IM6_C1 and IM6_C2 displayed by the edge area NFD1_A2 of the first non-folding portion NFD1 may be images adjusted to prevent distortion when viewed from the outside.

FIG. 26 is a perspective view of another embodiment of a display device. FIG. 27 is a cross-sectional view, taken along line X15–X15’, of FIG. 26. FIG. 28 is a perspective view illustrating a folded state of the display device of FIG. 26.

The following description focuses mainly on differences from the embodiment of FIG. 18, and repeated descriptions will be omitted.

Referring to FIGS. 26 and 27, compared to FIG. 18, a display device 10′_3 may include a display panel DP, a cover member CV, a hinge member HG, and a reflective member RF.

The cover member CV may be disposed below the display panel DP and may serve to support and protect the display panel DP. The cover member CV may include a recess for accommodating the display panel DP. The cover member CV may include a first cover member CV1 and a second cover member CV2 that are arranged in the first direction DR1.

The display panel DP may be disposed on the cover member CV. The display panel DP may be seated on the recess of the cover member CV. The display panel DP may be disposed in the first direction DR1 and may include first and second non-folding portions NFD1 and NFD2 overlapping the first and second cover members CV1 and CV2, respectively, of the cover member CV, and a folding portion FD disposed between the first and second non-folding portions NFD1 and NFD2. The first non-folding portion NFD1 may include a main area NFD1_A1 disposed outside the folding portion FD and an edge area NFD1_A2 disposed outside the main area NFD1_A1. When the display device 10′_3 is folded, the main area NFD1_A1 of the first non-folding portion NFD1 may not display an image, and only the edge area NFD1_A2 of the first non-folding portion NFD1 may display an image.

The hinge member HG may be disposed inside the cover member CV and may be connected with the cover member CV to serve as a folding axis around which to rotate the cover member CV. As illustrated in FIGS. 26 and 27, the hinge member HG may be covered by the cover member CV and not exposed to the outside in an unfolded state. The hinge member HG may overlap the folding portion FD of the display panel DP and may connect the first and second cover members CV1 and CV2.

The reflective member RF may be disposed on an inclined surface CV2_SL of the second cover member CV2. The reflective member RF may have a shape corresponding to the shape of the inclined surface CV2_SL of the second cover member CV2. The reflective member RF may reflect images displayed by the display panel DP in a folded state of the display device 10′_3 and may serve to provide the images to the outside of the display device 10′_3. In an embodiment, the reflective member RF may include a reflective metal material such as Cr or Al. In an alternative embodiment, in embodiments, the reflective member RF may be a reflective film including a non-metal material. In an alternative embodiment, in embodiments, the reflective member RF may be a mirror including glass.

As illustrated in FIG. 28, the display device 10′_3 may have a foldable structure that folds into an angled U-shape such that the display screen is not externally exposed in appearance. When the display device 10′ is folded, the cover member CV and the hinge member HG may be disposed on a surface of the display panel DP that is opposite to the image display surface of the display panel DP, and may overlap the display panel DP. Specifically, the second non-folding portion NFD2 of the display panel DP may be disposed on the second cover member CV2, the first non-folding portion NFD1 may be disposed on the second non-folding portion NFD2, the first cover member CV1 may be disposed on the first non-folding portion NFD1, and the hinge member HG may be disposed outside the folding portion FD of the display panel DP. Accordingly, in the folded state of the display device 10′_3, the display panel DP may be covered by the cover member CV and the hinge member HG and may not be externally exposed in appearance.

When the display device 10′_3 is folded, the edge area NFD1_A2 of the first non-folding portion NFD1 of the display panel DP may overlap the reflective member RF disposed on the inclined surface CV2_SL of the second cover member CV2. As the edge area NFD1_A2 of the first non-folding portion NFD1 of the display panel DP overlaps the reflective member RF in the folded state of the display device 10′_3, images displayed by the edge area NFD1_A2 of the first non-folding portion NFD1 of the display panel DP may be reflected by the reflective member RF and provided to the outside of the display device 10′_3. Accordingly, the display device 10′_3 may provide a notification image such as time, message, or mail to the user even in the folded state without requiring a separate display panel exposed on the exterior.

In an embodiment, in the folded state of the display device 10′_3, the screen refresh rate in the edge area NFD1_A2 of the first non-folding portion NFD1 of the display panel DP may be 1 Hz or less. Accordingly, the notification image displayed by the edge area NFD1_A2 of the first non-folding portion NFD1 may be provided to the outside of the display device 10′_3 by the reflective member RF under low-power driving.

FIG. 29 is a perspective view illustrating another embodiment of a folded state of a display device.

The following description focuses mainly on differences from the embodiment of FIG. 28, and repeated descriptions will be omitted.

Referring to FIG. 29, compared to FIG. 28, an inclined surface CV2_SL (refer to FIG. 27) of a second cover member CV2 may be a curved surface. A reflective member RF may have a shape corresponding to the shape of the inclined surface CV2_SL of the second cover member CV2. In a folded state of a display device 10′_5, images displayed by an edge area NFD1_A2 of a first non-folding portion NFD1 of a display panel DP may be reflected by a reflective member RF with a curved shape and be provided to the outside of the display device 10′_5. The images displayed by the edge area NFD1_A2 of the first non-folding portion NFD1 may be reflected by the reflective member RF and be provided to the outside in a direction inclined from the first direction DR1 toward the third direction DR3. In an embodiment, the images displayed by the edge area NFD1_A2 of the first non-folding portion NFD1 may be distorted images according to the curvature of the reflective member RF. Accordingly, when the reflective member RF has a curved shape, the images displayed by the edge area NFD1_A2 of the first non-folding portion may be notification images in the form of relatively small dots representing different colors. In an alternative embodiment, in embodiments, the images displayed by the edge area NFD1_A2 of the first non-folding portion NFD1 may be images adjusted to prevent distortion when viewed from the outside.

The display devices according to the aforementioned embodiments may be applied to various electronic devices. An electronic device in an embodiment may include any one of the display devices according to the aforementioned embodiments and may further include modules or devices that provide additional functions beyond the corresponding display device.

FIG. 30 is a block diagram of an embodiment of an electronic device.

Referring to FIG. 30, an electronic device 1 in an embodiment may include a display module 11, a processor 12, a memory 13, and a power module 14.

The processor 12 may include at least one of a central processing unit (“CPU”), an application processor (“AP”), a graphics processing unit (“GPU”), a communication processor (“CP”), an image signal processor (“ISP”), or a controller.

The memory 13 may store data and information desired for the operation of the processor 12 or the display module 11. When the processor 12 executes an application stored in the memory 13, image data signals and/or input control signals may be transmitted to the display module 11, and the display module 11 may process the received signals to output image information through a display screen.

The power module 14 may include a power supply module, such as a power adapter or a battery device, and a power conversion module that converts power supplied by the power supply module into power desired for the operation of the electronic device 1.

At least one of the aforementioned components of the electronic device 1 may be included in a display device according to any one of the aforementioned embodiments. Additionally, some of individual modules included functionally within a single module may be included in the display device, and others may be provided separately from the display device. In an embodiment, the display device may include the display module 11, while the processor 12, the memory 13, and the power module 14 may be provided as other devices included in the electronic device 1, for example.

FIG. 31 illustrates schematic diagrams of embodiments of electronic devices.

Referring to FIG. 31, various electronic devices to which the display devices in the embodiments are applied may include image display electronic devices such as a smartphone 1_1a, a tablet PC 1_1b, a laptop 1_1c, a television (“TV”) 1_1d, and a desktop monitor 1_1e, wearable electronic devices that include a display module, such as smart glasses 1_2a, a head-mounted display 1_2b, and a smart watch 1_2c, and vehicle electronic devices 1_3 that include a display module, such as a center information display (“CID”) disposed on the instrument panel, center fascia, or dashboard of a vehicle, and a room mirror display.

In concluding the detailed description, those skilled in the art will appreciate that many variations and modifications may be made to the preferred embodiments without substantially departing from the principles of the disclosure. Therefore, the disclosed preferred embodiments of the disclosure are used in a generic and descriptive sense only and not for purposes of limitation.

What is claimed is:

1. A foldable display device comprising:
a cover structure including:
first, second, and third non-folding cover portions which are arranged in a first direction;
a first folding cover portion which is disposed between the first and second non-folding cover portions; and
a second folding cover portion which is disposed between the second and third non-folding cover portions;
a display panel disposed on the cover structure, the display panel including:
first, second, and third non-folding portions which overlap the first, second, and third non-folding cover portions, respectively, of the cover structure; and
first and second folding portions which overlap the first and second folding cover portions, respectively; and
a reflective member disposed on a surface of the second folding cover portion of the cover structure which is opposite to a surface of the second folding cover portion facing the display panel,
wherein the first and second folding portions of the display panel are folded and unfolded by the first and second folding cover portions, respectively, of the cover structure.

2. The foldable display device of claim 1, wherein
the first and second folding cover portions are each folded in an in-folding manner toward the second non-folding cover portion in the first direction,
the second folding cover portion includes an inclined surface near the third non-folding cover portion in a folded state of the second folding cover portion, and
the reflective member overlaps the inclined surface.

3. The foldable display device of claim 2, wherein when the first and second folding cover portions are folded, the third non-folding portion and the third non-folding cover portion are disposed on the second non-folding portion and the second non-folding cover portion, the first non-folding portion and the first non-folding cover portion are disposed on the third non-folding portion and the third non-folding cover portion, the second folding cover portion and the reflective member are disposed outside the second and third non-folding cover portions, and one side of the first non-folding portion of the display panel overlaps the reflective member.

4. The foldable display device of claim 3, wherein when the first and second folding cover portions are folded, only the side of the first non-folding portion which overlaps the reflective member displays an image.

5. The foldable display device of claim 4, wherein when the first and second folding cover portions are folded, the image displayed by the side of the first non-folding portion which overlaps the reflective member is reflected by the reflective member and provided to an outside.

6. The foldable display device of claim 4, wherein when the first and second folding cover portions are folded, a screen refresh rate of the side of the first non-folding portion which overlaps the reflective member is 1 hertz or less.

7. The foldable display device of claim 2, wherein
the inclined surface is a planar surface, and
an inclination of the inclined surface is in a range of 20° to 70°.

8. The foldable display device of claim 2, wherein
the inclined surface includes a curved surface, and
the reflective member includes a shape identical to a shape of the inclined surface in a folded state of the second folding cover portion.

9. A foldable display device comprising:
a cover member including first, second, and third cover members which are arranged in a first direction;
a display panel disposed on the cover member, the display panel including:
first, second, and third non-folding portions which overlap the first, second, and third cover members, respectively;
a first folding portion which is disposed between the first and second non-folding portions; and
a second folding portion which is disposed between the second and third non-folding portions;
a hinge member disposed inside the cover member, the hinge member including:
a first hinge member which overlaps the first folding portion of the display panel and connects the first and second cover members; and
a second hinge member which overlaps the second folding portion of the display panel and connects the second and third cover members; and
a reflective member disposed on a surface of the second hinge member which is opposite to a surface of the second hinge member facing the display panel,
wherein
the surface of the second hinge member opposite to the surface of the second hinge member facing the display panel includes a first inclined surface overlapping the third cover member,
the reflective member overlaps the first inclined surface of the second hinge member, and
the first and second folding portions of the display panel are folded and unfolded by the first and second hinge members, respectively.

10. The foldable display device of claim 9, wherein
the first and second folding portions of the display panel are each folded in an in-folding manner toward the second non-folding portion in the first direction, and
when the first and second folding portions are folded, the third non-folding portion and the third cover member are disposed on the second non-folding portion and the second cover member, the first non-folding portion and the first cover member are disposed on the third non-folding portion and the third cover member, and a portion of the hinge member and the reflective member are exposed to an outside and disposed outside the cover member.

11. The foldable display device of claim 10, wherein when the first and second folding portions are folded, one side of the first non-folding portion of the display panel overlaps the reflective member.

12. The foldable display device of claim 11, wherein when the first and second folding portions are folded, only the side of the first non-folding portion which overlaps the reflective member displays an image.

13. The foldable display device of claim 12, wherein when the first and second folding portions are folded, the image displayed by the side of the first non-folding portion which overlaps the reflective member is reflected by the reflective member and provided to the outside.

14. The foldable display device of claim 12, wherein when the first and second folding portions are folded, a screen refresh rate of the side of the first non-folding portion which overlaps the reflective member is 1 hertz or less.

15. The foldable display device of claim 9, wherein
the first inclined surface is a planar surface, and
an inclination of the first inclined surface is in a range of 20° to 70°.

16. The foldable display device of claim 15, wherein
the surface of the second hinge member facing the display panel includes a second inclined surface overlapping the second cover member, and
the first and second inclined surfaces have different shapes from each other.

17. The foldable display device of claim 9, wherein the first inclined surface includes a curved surface.

18. The foldable display device of claim 17, wherein
the surface of the second hinge member facing the display panel includes a second inclined surface overlapping the second cover member, and
the second inclined surface has a shape identical to a shape of the first inclined surface.

19. The foldable display device of claim 9, wherein when the display panel is unfolded, the hinge member and the reflective member are not exposed to an outside by the cover member.

20. An electronic device comprising:
a display device configured to display an image, the display device comprising:
a cover member including first, second, and third cover members which are arranged in a first direction;
a display panel disposed on the cover member and including first, second, and third non-folding portions which overlap the first, second, and third cover members, respectively;
a first folding portion which is disposed between the first and second non-folding portions; and
a second folding portion which is disposed between the second and third non-folding portions;
a hinge member disposed inside the cover member, the hinge member including:
a first hinge member which overlaps the first folding portion of the display panel and connects the first and second cover members; and
a second hinge member which overlaps the second folding portion of the display panel and connects the second and third cover members; and
a reflective member disposed on a surface of the second hinge member which is opposite to a surface of the second hinge member facing the display panel; and
a processor configured to transmit image data signals for displaying the image to the display device,
wherein the surface of the second hinge member which is opposite to the surface of the second hinge member facing the display panel includes a first inclined surface overlapping the third cover member,
the reflective member overlaps the first inclined surface of the second hinge member, and
the first and second folding portions of the display panel are folded and unfolded by the first and second hinge members, respectively.
